(19) United States
(12) Patent Application Publication
(10) Pub. No.: US 2007/0022061 A1
(43) Pub. Date: Jan. 25, 2007

(54) Optimizing solutions using local virtual forces

(75) Inventors: Marshall Seth Brinn, Newton, MA (US); Subramanian Ramanathan, Westford, MA (US); Aaron Helsinger, Somerville, MA (US)

Correspondence Address: PROSKAUER ROSE LLP, ONE INTERNATIONAL PLACE 14TH FL, BOSTON, MA, 02110, US

(73) Assignee: BBNT Solutions LLC, Cambridge, MA (US)

(21) Appl. No.: 11/287,576

(22) Filed: Nov. 23, 2005

Related U.S. Application Data
(60) Provisional application No. 60/701,185, filed on Jul. 20, 2005.

(51) Int. Cl. G06F 15/18

(52) U.S. Cl. 706/13

(57) ABSTRACT

Described are methods and apparatus, including computer program products, for optimizing solutions using local attractive and/or repulsive virtual forces. In one aspect, a first virtual force is defined that is associated with an attractive characteristic and has a weighting parameter. A second virtual force is defined that is associated with a repulsive characteristic and has a weighting parameter. A detected virtual force is received that includes the first virtual force, the second virtual force, or a combination thereof. At an element associated with receiving the detected virtual force, a path is selected from a plurality of available paths based on the detected virtual force.

### CROSS REFERENCES TO RELATED APPLICATIONS

This application claims the benefit of U.S. Provisional Application Ser. No. 60/701,185, filed on Jul. 20, 2005, the disclosure of which is hereby incorporated herein by reference.

### GOVERNMENT RIGHTS

The government may have certain rights in the invention under Contract No. MDA972-01-C-0025.

### FIELD OF THE INVENTION

The present invention relates to optimizing solutions using local virtual forces.

### BACKGROUND

Generally, a complex problem can refer to an issue in which multiple parameters are taken into account. A complex solution can refer to a solution to which there are many components or aspects. A classic example of a complex problem is the delivery truck problem, where given a certain number of destinations and routes between those destinations, a solution (e.g., a round trip route) is derived so that the driver can visit each destination once. Because there are many destinations and routes, there can be many different solutions. Optimizing those solutions requires assigning a cost to the components or aspects of the solution (e.g., each route between destinations) and then choosing the solution with the lowest cost. When the environment is static, a solution with the lowest cost can be determined, and that solution can be implemented because nothing changes during execution.

In complex problems, often the environment is not static. Algorithms have been developed to address solutions where the environment is uncertain or stochastic. For example, a dissertation by Anawat Pongpunwattana, titled “Real-Time Planning for Teams of Autonomous Vehicles in Dynamic Uncertain Environments” describes “algorithms for solving real-time task and path planning problems by combining Evolutionary Computation (EC) based techniques with a Market-based planning architecture.” In this exemplary paper, the planning is done using a distributed planner architecture with a single active coordinator. In another paper by Hossein Jula, Maged Dessouky, Petros Ioannou, and Randolph Hall, titled “Full-Truck-Load Assignment and Route Planning in Deterministic and Stochastic Environments,” the authors describe methods for truck scheduling and route planning in changing environments where there is a time window in which deliveries are to be made. In this exemplary paper, the planning and scheduling is done by a centralized planner.

In another paper titled “Motion Planning using Potential Fields” by Randal W. Beard and Timothy W. McLain, the authors describe using potential fields to control the motion of a robot. Boundaries and objects are modeled as potential fields and the gradients of those fields are plotted in the area in which the robot moves. The robot is programmed to respond to the plot by orienting itself in the direction of the negative gradient while simultaneously moving at a velocity that is proportional to the projection of the velocity vector onto the negative gradient.

### SUMMARY OF THE INVENTION

In general overview, there are techniques for an optimizing solution using local virtual forces. The techniques can include methods and systems, including computer program products. In one aspect, a first virtual force is defined that is associated with an attractive characteristic and has a weighting parameter. A second virtual force is defined that is associated with a repulsive characteristic and has a weighting parameter. A detected virtual force is received that includes the first virtual force, the second virtual force, or a combination thereof. At an element associated with receiving the detected virtual force, a path is selected from a plurality of available paths based on the detected virtual force.

In other examples, one or more of the following features can be present. The selection can be based on properties, characteristics, and/or analysis of the detected virtual force, information associated with the detected virtual force, and/or the like. The solution can be derived locally. That is, an entity receives the detected virtual force and acts based on only that information which the entity has locally. For example, the entity determines which direction to travel based only on the received detected virtual force. The solution can be associated with logistics planning. Logistics planning includes a supplier of an item, a consumer of the item (demander), and a deliverer of the item (transporter). If the deliverer is receiving the detected virtual force, the first virtual force can be associated with the supplier of the item and/or the consumer of the item. The second virtual force can be associated with the deliverer of the item. In this way, the deliverer is attracted to suppliers and consumers of the item, while being repulsed by other deliverers of the item. The virtual forces can represent a reactive characteristic or an anticipatory characteristic. The reactive virtual forces can be based on a state associated with an element generating the virtual forces. For example, the virtual forces can be based on the item, such as a quantity of the item. In such examples, a supplier who has that item generates a virtual force so long as the supplier has that item. Similarly, a consumer who needs that item generates a virtual force so long as that consumer needs that item. The anticipatory virtual forces are based on location so that a balanced distribution of deliverers over an area can be maintained. For example, a deliverer generates an anticipatory force so that other deliverers can be repulsed, so that three deliverers are not all responding to a reactive force generated by a consumer in need. In another example, the consumer can also generate an anticipatory virtual force. In this way, deliverers stay close to a consumer for the eventual response when the consumer needs the item.

In addition to reactive and anticipatory forces, auxiliary virtual forces can also be defined. An auxiliary virtual force is associated with stability and/or efficiency for further optimization. An auxiliary virtual force can include oscillation avoidance, random perturbation, and/or inertia. For example, a random perturbation ensures that a deliverer does not become stuck between two equal virtual forces causing motion in opposite directions. In such a scenario, the random perturbation virtual force causes the deliverer to move in one direction, based on the random perturbation virtual force.

There can be a transportation network. The transportation network can be represented by nodes and links. The solution using the virtual forces can take into account distances along the links and redundancy through the network to travel, for example from the deliverer to a consumer in need of the item. The solution using the virtual forces can also take into account speeds that can be traveled on the transportation network, so that paths through redundant links of equal distance might result in different times based on achievable speeds through the different links. The links can include roads, waterways, air routes, and the like.

Receiving the detected virtual force can include receiving a signal representing the virtual force. The signal can be analyzed for strength, for example, to determine distance from the entity generating the signal. The signal can include information representing location. The location information can represent the location of the entity generating the signal. The location information can be based on a GPS signal. Receiving the detected virtual force can be based on a distance from a source of the detected virtual force. The distance can be based on one or more of the available paths.

The virtual forces can also be based on a force function. The function can be based on different parameters. For example, a force function can include a maximum distance parameter. This parameter is used to limit the effect of a generated virtual force to a certain distance. In another example, the force function can be dependent on other parameters of a model. For example, in a terrain based model, virtual forces can be dependent on the traversability of the terrain. In other examples, the force functions can be computed from the gradient of local pressures imposed by other local entities (e.g., suppliers, consumers (sometimes referred to as demanders), and/or deliverers (sometimes referred to as transporters)).

There also can be a genetic algorithm. The genetic algorithm can be employed to determine the values of the weight and maximum distance parameters. The genetic algorithm can take into account the environment in which the transportation network is located. For example, in a hostile environment where some links can be dynamically eliminated (or perhaps the maximum speed that can be achieved can be dynamically changed), redundancy of links is giving a higher weight.

The use of the virtual forces to solve the logistic solution is advantageous because it can account for dynamic changes that can occur. The solution can change as any of the consumer, the deliver, and/or the supplier move throughout the area, as the transportation network changes, as the amount of items changes (e.g., a supplier may be unexpectedly eliminated), etc. The use of local calculation enables optimization at the local level, thus allowing for an overall satisfactory solution as unexpected events occur. The use of a genetic algorithm for parameter calculation enables solutions to be calculated for different environments. The inclusion of both reactive and anticipatory virtual forces increases performance, as the use of the anticipatory forces ensures that the deliverers are balanced throughout the transportation network and thus available for the future needs as well as the immediate needs. One implementation may provide all of the above advantages.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

FIG. 1 is a block diagram showing a system for optimizing solutions using local virtual forces.

FIG. 2 is another block diagram showing a system for optimizing solutions using local virtual forces.

FIG. 3 is another block diagram showing a system for optimizing solutions using local virtual forces.

FIG. 4 is another block diagram showing a system for optimizing solutions using local virtual forces.

FIG. 5 is a screen shot showing a computer simulation of a system for optimizing solutions using local virtual forces.

FIG. 6 is another block diagram showing a system for optimizing solutions using local virtual forces.

### DETAILED DESCRIPTION

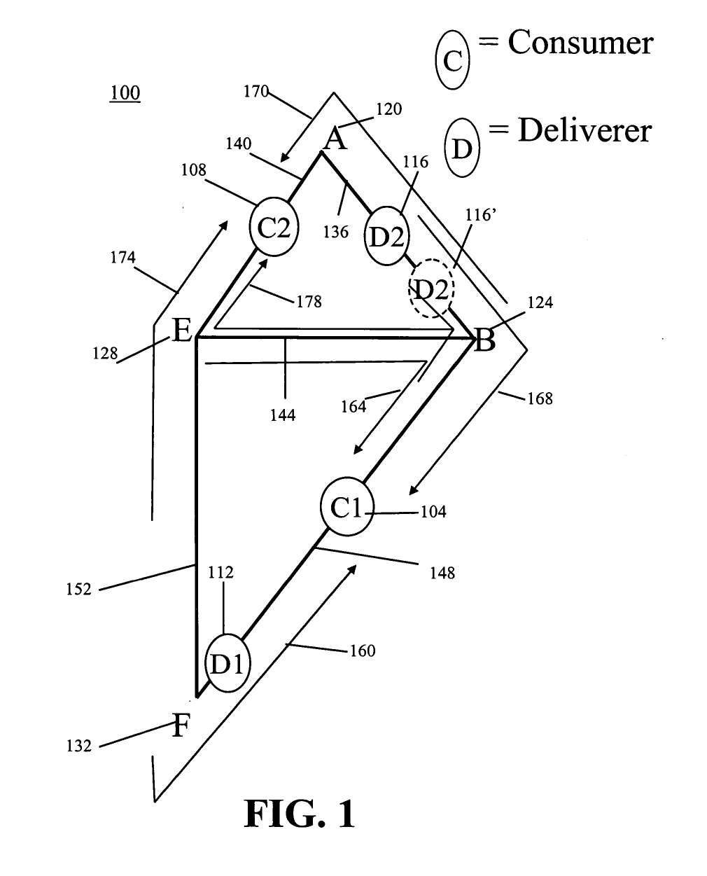

FIG. 1 illustrates an exemplary system 100 for optimizing solutions using local virtual forces. In system 100, there is a transportation network on which multiple vehicles travel. There are two consumer vehicles C1 104 and C2 108. The consumer vehicles are named so because in logistics planning, the vehicles C1 104 and C2 108 consume supplies (e.g., items such as gas, food, ammunition, etc.). In a military environment, the vehicles C1 104 and C2 108 can be, for example, Stryker armored vehicles. There are also two deliverer vehicles D1 112 and D2 116. The deliverer vehicles are named so because in logistics planning, the vehicles D1 112 and D2 116 deliver the needed supplies (e.g., items such as gas, food, ammunition, etc.) to a consumer. In a military environment, the vehicles D1 112 and D2 116 can be, for example, supply trucks.

The transportation network on which the vehicles C1 104, C2 108, D1 112, and D2 116 travel include nodes A 120, B 124, E 128, and F 132. The transportation network also includes links AB 136, AE 140, BE 144, BF 148, and EF 152. These links and nodes can represent, for example, roads and their intersections on which the vehicles can travel. If the roads are navigable (e.g., the vehicles can travel on them), then the links and/or nodes, or portions thereof, represent the available paths on which the vehicles can travel.

In logistics planning, a solution dictates which deliverer will go to which consumer, when the deliverer will do so, and how the deliverer will do so (e.g., which paths to use). In a static environment, such a solution can be obtained prior to execution and then simply executed as dictated. In a dynamic environment, however, unanticipated events, such as a link (e.g., road) becoming unnavigable, can make a predefined solution unusable. The system 100 uses virtual forces and local decision making to generate a solution that is adaptable to a dynamic environment. In the system 100 there are three virtual forces 160, 164, and 168 that are generated based on some state of the consumer C1 104, such as its location or quantity of supplies. Similarly, there also are three virtual forces 170, 174, and 178 that are generated based on some state of the consumer C2 108, such as its location or quantity of supplies. Under certain conditions, the deliverers D1 112 and D2 116 receive these virtual forces and decide how to react (e.g., where to go). The reaction is based on the different characteristics of the virtual force, such as its type, its magnitude, its weight, its maximum distance, etc. For example, if the virtual force 160 is a reactive type of virtual force associated with an attractive characteristic with respect to the deliverer D1 112, then the deliverer D1 112 follows the available path, road segment FB 148, in the direction towards the consumer C1 104.

One type of virtual force is an anticipatory type virtual force. Table 1 illustrates two exemplary anticipatory type virtual forces and their behaviors. One is a consumer attract anticipatory virtual force and the other is a deliverer repel anticipatory virtual force.

TABLE 1

| Force | | | | |
|---|---|---|---|---|
| name | Type | Magnitude | Direction | Parameters |
| Consumer | Anticipatory | Constant | Towards the farthest | WEIGHT, |
| Attract | | | NEARBY consumer | MAX_DIST |
| Deliverer | Anticipatory | Constant | Away from nearest | WEIGHT, |
| Repel | | | NEARBY truck | MAX_DIST |

The exemplary consumer attract anticipatory virtual force is generated by a consumer, is based on the location of the consumer (e.g., via its max distance parameter), and has an attractive characteristic when received by a deliverer. An attractive characteristic is one in which the force is in a direction towards the source of the virtual force associated with the attractive characteristic. The consumer attract force has a weight parameter and a maximum distance parameter. The weight parameter allows the receiver (e.g., the deliverer) to determine the strength of this force as compared to other virtual forces also received by that same receiver. The max distance parameter sets a limit as to how far away from a consumer a deliverer is able to receive the virtual force. In some examples, the maximum distance is measured along an available path (e.g., one or more road links) and is not a straight line (e.g., line-of-sight) measurement. For example, if FIG. 1 was drawn perfectly to scale (which it is not) and if the virtual forces 160, 164, 168, 170, 174, and 178 represented virtual forces all with the same value for the maximum distance parameter, then the arrows representing the virtual forces 160, 164, 168, 170, 174, and 178 would all be identical lengths, indicating the limits where those forces could be received. The magnitude of this force does not vary with distance. So, if a deliverer is within the maximum distance for several consumers, then that deliverer receives the consumer attract force from each consumer at equal magnitudes and equal weights.

Referring to the direction column of Table 1, the reaction of the deliverer, when the deliverer receives these consumer attract forces from several consumers, is to move towards the farthest nearby consumer. A consumer is a nearby consumer if that consumer is within the value set for the maximum distance. The deliverer moves towards the farthest nearby consumer, because, in trying to anticipate how to best service all of the consumers without knowledge of which consumer will need supplies first, the deliverer wants to try to stay equally spaced between all of the nearby consumers.

As an illustrative example, using the system 100, the virtual forces 168 and 170 can be consumer attract anticipatory virtual forces of Table 1. In this example, the deliverer D2 116 is within the value of the maximum distance from the consumer C1 104 via the road links BF 148 and AB 136. The deliverer D2 116 is also within the value of the maximum distance from the consumer C2 108 via the road links AE 140 and AB 136. Because the deliverer D2 116 is within the maximum distance for both consumers, the deliverer D2 116 receives the consumer attract force 168 from the consumer C1 108 and the consumer attract force 170 from the consumer C2 108. For the consumer attract forces of Table 1, the deliverer D2 116 selects a path toward the farthest nearby consumer. In this case, because the consumer C1 104 is farther away from the deliverer D2 116 than the consumer C2 108 is, the deliverer D2 116 selects to travel along the AB link 136 towards the node B 124, which is towards the farthest nearby consumer C1 104.

By selecting locally at the deliverer D2 116 based on the received forces, the deliverer D2 116 can advantageously update those selections and change paths as the environment changes. For example, as the consumer C1 104 and/or the consumer C2 108 move around, the deliverer can change its position based on their movement. Similarly, if a path becomes unavailable, the deliverer D2 116 can advantageously update those selections and change paths, eliminating the destroyed path from its selection. For example, if the road segment AB 136 is destroyed between the deliverer D2 116 and the consumer C1 104 and the deliverer D2 116 cannot navigate through the destroyed portion, the deliverer D2 116 does not elect to travel towards the consumer C1 104 and instead travels toward the consumer C2 108. In some examples, the deliverer D2 116 has a map of the road network (e.g., an electronic version) and when a link is destroyed, the map is updated (e.g., via an external source) to reflect this. In some examples, the indication is that the deliverer D2 116 determines the road is no longer navigable and the deliverer D2 116 removes the consumer attract force 168 from the selection process (e.g., does not consider that force in its selection process). In some examples, when the road segment is destroyed, the deliverer D2 116 no longer receives the consumer attract force 168 from the consumer C1 108.

Instead of being completely destroyed, a link can be impaired or become less navigable, due to, for example, heavy traffic or other roads conditions which slow the speed of travel. A portion of the road links can go through an urban area that is more congested, more traffic lights, pedestrians, and other obstacles than outside of the urban area and as a result, slow down the travel through these urban areas. In such situations, the virtual forces following the links through these urban areas can include information, that make those links less desirable to be selected by a deliverer, than links on which travel is easier and faster. The local selection process also advantageously allows a deliverer to take advantage of redundant paths to achieve the same goal. For example, if the deliverer D2 116 moves towards the farthest nearby consumer, which is the consumer C1 104, the deliverer D2 116 reaches a location, indicated by the dashed line deliverer D2 116′, at which the deliver D2 116′ receives a second anticipatory consumer attract virtual force from the consumer C2 108. In this case, the deliver D2 at position 116′ uses the shortest distance path of the two redundant paths to the consumer C2 108 when determining which of the consumers C1 104 or C2 108 is the farthest nearby consumer.

The redundant path also provides the deliverer D2 116′ with another available path to reach C2. If the road network changes, for example the link AB 136 becomes unnavigable at the node A 120, the deliverer D2 116′ can still reach C2 via the EB link 144 and includes that path in its selection process since the deliverer D2 116′ is now within the value for the maximum distance parameter along that second path. In the first position of the deliverer D2 116 (non-dashed line), there was no anticipatory virtual force from the consumer C2 108 along the link BE 144. As the position of the deliver D2 changed (from 116 to 116′), the available paths for selection changed with the receipt of additional virtual forces. This example emphasizes the advantage of the use of virtual forces to enable the logistics planning solution to change as the position of the entities (e.g., the consumers and/or the deliverers) change.

Referring to Table 1, the other exemplary anticipatory force is the deliverer repel anticipatory virtual force. The deliverer repel anticipatory virtual force is generated by a deliverer, based on its location (e.g., via its max distance parameter), and has a repulsive characteristic when received by another deliverer. A repulsive characteristic is one in which the force is in a direction away from the source of the virtual force associated with the repulsive characteristic. The deliverer repel force has a weight parameter and a maximum distance parameter. The weight parameter allows the receiver (e.g., another deliverer) to determine the strength of this force as compared to other virtual forces also received by that same receiver. The max distance parameter sets a limit as to how far away from one deliverer another deliverer is able to receive the virtual force. In some examples, the maximum distance is measured along an available path (e.g., one or more road links) and is not a straight line (e.g., line-of-sight) measurement. The magnitude of this force does not vary with distance. So, if a deliverer is within the maximum distance for several deliverers, then that deliverer receives the deliverer repel force from each deliverer at equal magnitudes and equal weights.

Referring to the direction column of Table 1, the reaction of the deliverer, when the deliverer receives one or more deliverer repel forces is to move away from the nearest nearby deliverer. A deliverer is a nearby deliver if that deliverer is within the value set for the maximum distance. The deliverer moves away from the nearest deliverer, because, in trying to anticipate how to best serve consumers from a local decision making process, without knowledge of where every other consumer or deliverer is located, the deliverer wants to try to stay away from any nearby deliverers, since those nearby deliverers can service consumers that are close to them.

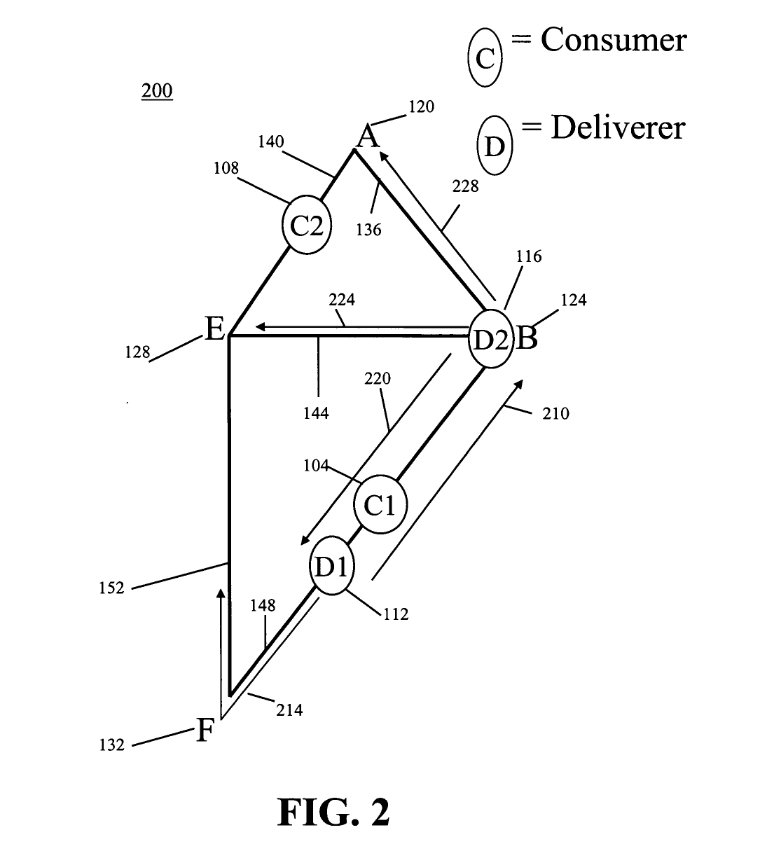

FIG. 2 illustrates an exemplary system 200, that includes an identical road network (i.e., the nodes 120, 124, 128, and 132, and the links 136, 140, 144, 148 and 152) and vehicles (i.e., the consumers C1 104 and C2 108 and the deliverers D1 112 and D2 116) as the system 100. The system 200 includes virtual forces 210, 214, 220, 224, and 228. The virtual forces 210, 214, 220, 224, and 228 can be deliverer repel anticipatory virtual forces of Table 1. The deliverer repel anticipatory virtual forces 210 and 214 are generated based on the location of the deliverer D 112. The deliverer repel anticipatory virtual forces 220, 224, and 228 are generated based on the location of the deliverer D2 116.

In this example, the deliverer D1 112 is within the value of the maximum distance from the deliverer D2 112 via the road link BF 148. Because the deliverers D 112 and D2 116 are within the maximum distance, they each receive a deliverer repel anticipatory virtual force from the other. More specifically, the deliverer D1 112 receives the deliverer repel force 220 based on the location of the deliverer D2 116 and the deliverer D2 116 receives the deliverer repel force 210 based on the location of the deliverer D1 112. For the deliverer repel forces of Table 1, the receiver deliverer selects a path away from the nearest nearby deliverer. Absent any other virtual forces, the deliverers D1 112 and D2 116 move away from each other. When, however, a deliver receives other virtual forces in addition to the deliverer repel force, the deliver reacts in accordance with the resultant combination of all of the received virtual forces.

For example, the deliverer D2 116 can receive anticipatory consumer attract forces from both the consumer C1 104 and the consumer C2 108 of equal weight. Accounting for those forces only, the deliverer D2 116 moves so that it is situated an equal distance from the consumer C1 104 and C2 108 (e.g., in the middle of C1 and C2). As described above, the anticipatory consumer attract forces attract the deliverer D2 116 to each consumer, so the deliverer D2 116 tries to find a happy medium centered between the two consumers. When, however, the deliverer D2 116 receives the deliverer repel force 210 from D1 112, this force is added to the consumer attract forces. If, for example, the weights of the consumer attract forces and the deliverer repel forces are the same, then the deliverer D2 116 has one force attracting it towards the consumer C1 104 and two forces pushing it away from the consumer C1 104 and towards the consumer C2 108. In such a situation, the deliverer D2 116 moves away from the middle of the consumers C1 and C2 and instead starts moving closer towards the consumer C2 108.

The above-described forces are anticipatory type virtual forces. Another type of virtual force is a reactive type virtual force. Table 2 illustrates two exemplary reactive type virtual forces and their behaviors. One is a consumer parts refill attract reactive virtual force and the other is a supplier parts refill attract reactive virtual force.

TABLE 2

| Force | | | | |
|---|---|---|---|---|
| name | Type | Magnitude | Direction | Parameters |
| Consumer | Reactive | #parts/distance | Towards a path | WEIGHT, |
| Parts | | | along which most | MAX_DIST |
| Refill | | | forces can be | |
| Attract | | | satisfied with | |
| | | | current inventory | |
| Supplier | Reactive | #parts/distance | Towards shortest | WEIGHT, |
| Parts | | | path to a supplier | MAX_DIST |
| Refill | | | | |
| Attract | | | | |

The exemplary consumer parts refill attract reactive virtual force is generated by a consumer, is based on the quantity of supplies of the consumer (e.g., the number of parts on hand for that consumer), and has an attractive characteristic when received by a deliverer. The consumer parts refill attract force has a weight parameter and a maximum distance parameter. The weight parameter allows the receiver (e.g., the deliverer) to determine the strength of this force as compared to other virtual forces also received by that same receiver. The weighting can vary between the same type forces. For example, a more critical supply, such as fuel, can have a higher weight than a less critical supply, such as additional clothing and gear. The weighting can also vary as compared between different types of forces. For example, reactive forces can have higher weights than anticipatory forces, since reactive forces involve actual diminished supplies, whereas anticipatory forces involve attempting to predict future needs.

The max distance parameter sets a limit as to how far away from a consumer a deliverer is able to receive the virtual force. In some examples, the maximum distance is measured along an available path (e.g., one or more road links) and is not a straight line (e.g., line-of-sight) measurement. The magnitude of this force does vary. In this example, the force varies with the quantity of supplies and the distance. For example, if fuel is the supply associated with the force, as the fuel supply becomes lower, the magnitude of the force increases. So, if a deliverer is within the maximum distance for several consumers, then that deliverer receives the consumer parts refill attract force from each consumer at different magnitudes, depending on the quantity of the associated supply for each consumer. For the example of higher magnitudes for lower fuel supplies, the deliverer is attracted to (e.g., receives the strongest virtual force from) the consumer with the least amount of fuel. The magnitude is also dependent on the distance between the consumer and the deliverer. The signal decays with distance, so that the further away from the consumer the deliverer is, the lower in magnitude the strength of the force will be. The decay over distance is parametric and can vary, for example, being a straight line decay of some slope, being an exponential decay, etc.

Referring to the direction column of Table 2, the reaction of the deliverer, when the deliverer receives these consumer parts refill attract forces from several consumers, is to move towards a path along which most forces can be satisfied with the current inventory of the deliverer. For example, if the deliverer receives consumer parts refill attract reactive forces for two different supplies, but only has one of the supplies, the deliverer is attracted only to the consumer in need of those supplies that the deliverer has. This can happen even if the weights are not equal.

As an illustrative example, using the system 100, the virtual forces 168 and 170 can be consumer parts refill attract reactive virtual forces of Table 2. In this example, the deliverer D2 116 is within the value of the maximum distance from the consumer C1 104 via the road links BF 148 and AB 136. The deliverer D2 116 is also within the value of the maximum distance from the consumer C2 108 via the road links AE 140 and AB 136. Because the deliverer D2 116 is within the maximum distance for both consumers, the deliverer D2 116 receives the consumer parts refill attract reactive force 168 from the consumer C1 108 and the consumer parts refill attract reactive force 170 from the consumer C2 108. For the consumer parts refill attract reactive forces of Table 2, the deliverer D2 116 selects a path along which most forces can be satisfied with current inventory of the deliverer D2 116. The path the deliverer D2 116 selects is different in different scenarios.

In one scenario, both consumers C1 104 and C2 108 need the same amount of the same supply. In this scenario, because the consumer C1 104 is farther away from the deliverer D2 116 than the consumer C2 108 is, and thus the magnitude of the force is decayed more, the deliverer D2 116 selects to travel along the AB link 136 towards the node A 120, which is towards the closest consumer C2 108, since all other considerations are equivalent. In another scenario, the consumer C2 108 needs more of a supply (e.g., has a lower quantity) than the consumer C1 104, so the magnitude of the virtual force 170 is greater than the virtual force 168 over a distance. In this scenario, because the consumer C2 108 is closer to the deliverer D2 116 than the consumer C1 104 and the consumer C2 108 is in greater need of supplies, the deliverer D2 116 selects to travel along the AB link 136 towards the node A 120, which is towards the consumer C2 108. In another scenario, the consumer C1 104 needs more of a supply (e.g., has a lower quantity) than the consumer C2 108, so the magnitude of the virtual force 168 is greater than the virtual force 170 over a distance. In this scenario, even though the consumer C2 108 is closer to the deliverer D2 116 than the consumer C1 104, the consumer C1 104 is in greater need of supplies, and the magnitude of the force, even with decay over distance is greater from the consumer C1 104 than the consumer C2 108. In such a case, the deliverer D2 116 selects to travel along the AB link 136 towards the node B 124, which is towards the consumer C1 104. There is a location in this scenario where the strength of the force of the consumer C1 104 is smaller than that of the consumer C2 108, even though the consumer C1 104 has a greater need, because of the decay over the greater distance.

In another scenario, the consumer C2 108 needs one particular supply of a low priority (e.g., low value for weight parameter), for example clothing and gear. The consumer C1 104, needs one particular supply of a higher priority (e.g., higher value for weight parameter than C2 108), for example fuel. In this scenario, the virtual force 169 has a greater attraction than the virtual force 170 over a distance. In this scenario, the weighting becomes a stronger parameter than the decay over distance. In light of this, because the consumer C1 104 has a greater need of supplies, because of the higher priority (weighting), than the consumer C2 108, the deliverer D2 116 selects to travel along the AB link 136 towards the node B 124, which is towards the consumer C1 104. This illustrates the optimization between values of parameters (e.g., weight, decay) and how one parameter can become more influential than another and cause different results. For example, if the magnitude decayed more over distance than the difference in weighting, the deliverer D2 116 might select to travel along the AB link 136 towards the node A 120 because, even at a lower priority, the consumer C2 108 would produce a higher magnitude force since it is closer.

By selecting locally at the deliverer D2 116 based on the received forces, the deliverer D2 116 can advantageously update those selections and change paths as the environment changes. For example, as the consumer C1 104 and/or the consumer C2 108 move around and deplete their supplies, the deliverer can change its position based on their movement and usage of supplies. Similarly, if a path becomes unavailable, impaired and/or less navigable, the deliverer D2 116 can advantageously update those selections and change paths, eliminating the destroyed path from its selection. For example, if the road segment AB 136 is destroyed, impaired or becomes less navigable between the deliverer D2 116 and the consumer C1 104 and the deliverer D2 116 cannot navigate at full speed through the that portion, the deliverer D2 116 does not elect to travel towards the consumer C1 104 and instead travels toward the consumer C2 108. In some examples, the deliverer D2 116 has a map of the road network (e.g., an electronic version) and when a link is destroyed, impaired or becomes less navigable, the map is updated (e.g., via an external source) to reflect this. In some examples, the indication is that the deliverer D2 116 determines the road is no longer navigable and the deliverer D2 116 removes the consumer parts refill attract force 168 from the selection process (e.g., does not consider that force in its selection process). In some examples, when the road segment is destroyed, the deliverer D2 116 no longer receives the consumer parts refill attract force 168 from the consumer C1 108. In some examples, if the road is navigable but impaired, the deliverer D2 116 receives the consumer parts refill attract force 168 from the consumer C1 108 at some reduced strength, for example, proportional to the impairment (e.g., a 50% reduction if the speed limit has been reduced 50% due to impairments, e.g., heavy traffic). In some examples, if the deliverer D2 116 has knowledge, but the consumer C1 108 does not, the deliverer D2 116 can discount the received virtual force by some amount (e.g., a 50% reduction if the speed limit has been reduced 50% due to impairments, e.g., heavy traffic).

Referring to Table 2, the other exemplary reactive force is the supplier parts refill attract reactive virtual force. The exemplary supplier parts refill attract reactive virtual force is generated by a supplier, is based on the quantity of supplies of the supplier (e.g., the number of parts on hand for that supplier), and has an attractive characteristic when received by a deliverer. The supplier parts refill attract reactive virtual force has a weight parameter and a maximum distance parameter. The weight parameter allows the receiver (e.g., the deliverer) to determine the strength of this force as compared to other virtual forces also received by that same receiver. The weighting can vary between the same type forces. For example, a more critical supply, such as fuel, can have a higher weight than a less critical supply, such as additional clothing and gear. The weighting can also vary as compared between different types of forces. For example, reactive forces can have higher weights than anticipatory forces, since reactive forces involve actual diminished supplies, whereas anticipatory forces involve attempting to predict future needs.

The max distance parameter sets a limit as to how far away from a supplier a deliverer is able to receive the virtual force. In some examples, the maximum distance is measured along an available path (e.g., one or more road links) and is not a straight line (e.g., line-of-sight) measurement. The magnitude of this force does vary. In this example, the force varies with the quantity of supplies and with distance. For example, if fuel is the supply associated with the force, as the fuel supply becomes lower, the magnitude of the force decreases. So, if a deliverer is within the maximum distance for several suppliers, then that deliverer receives the supplier parts refill attract force from each supplier at different magnitudes, depending on the quantity of the associated supply for each supplier. For the example of higher magnitudes for higher fuel supplies, the deliverer is attracted to (e.g., receives the strongest virtual force from) the supplier with the most amount of fuel. The magnitude is also dependent on the distance between the supplier and the deliverer. The signal decays with distance, so that the further away from the supplier the deliverer is, the lower in magnitude the strength of the force will be. The decay over distance is parametric and can vary, for example, being a straight line decay of some slope, being an exponential decay, etc.

Referring to the direction column of Table 2, the reaction of the deliverer, when the deliverer receives these supplier parts refill attract forces from several suppliers, is to move towards the shortest path to a supplier. For example, if the deliverer receives supplier parts refill attract reactive forces for two different supplies, the deliverer is attracted to the closest supplier (e.g., closest measured in terms of the path lengths (road link lengths)) that has those supplies that the deliverer needs.

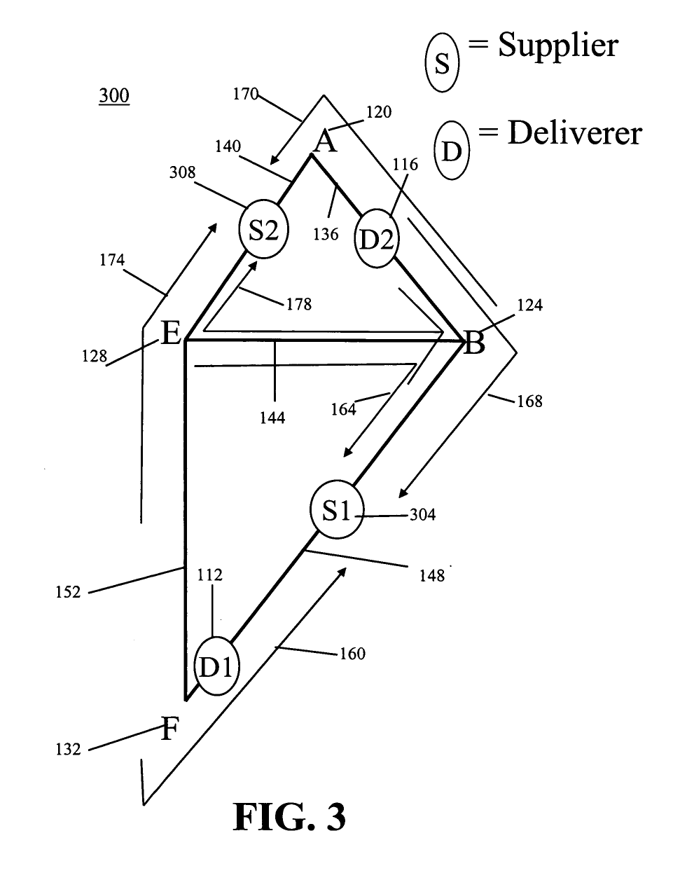

FIG. 3 illustrates an exemplary system 300, that includes an identical road network (i.e., the nodes 120, 124, 128, and 132, and the links 136, 140, 144, 148 and 152), vehicles (i.e., the deliverers D1 112 and D2 116), and virtual forces (i.e., 160, 164, 168, 170, 174, and 178) as the system 100. In the system 300, the virtual forces 160, 164, 168, 170, 174, and 178 represent the supplier parts refill attract reactive virtual forces of Table 2. The supplier parts refill attract reactive virtual forces 160, 164, and 168 are generated based on the location of a supplier S1 304 and the quantity of its supply. The supplier parts refill attract reactive virtual forces 170, 174, and 178 are generated based on the location of a supplier S2 308 and the quantity of its supply.

In the system 300, the deliverer D1 112 is within the value of the maximum distance from the supplier S1 304 via the road link BF 148. Because this is the only virtual force received by the deliverer D1 112, the deliverer D1 112 is attracted to the supplier S1 304, provided the supply associated with the virtual force 160 is one that is needed by the deliverer D1 112.

In the system 300, the deliverer D2 116 is within the value of the maximum distance from the supplier S1 304 via the road links BF 148 and AB 136. The deliverer D2 116 is also within the value of the maximum distance from the supplier S2 308 via the road links AE 140 and AB 136. Because the deliverer D2 116 is within the maximum distance for both suppliers, the deliverer D2 116 receives the supplier parts refill attract reactive force 168 from the supplier S1 304 and the supplier parts refill attract reactive force 170 from the supplier S2 308. For the supplier parts refill attract reactive forces of Table 2, the deliverer D2 116 selects a path towards the closest supplier with a supply needed by the deliverer D2 116. The path the deliverer D2 116 selects is different in different scenarios.

In one scenario, both suppliers S1 304 and S2 308 have the same amount of the same supply. In this scenario, because the supplier S1 304 is farther away from the deliverer D2 116 than the supplier S2 308 is, the deliverer D2 116 selects to travel along the AB link 136 towards the node A 120, which is towards the closest supplier S2 308, since all other considerations are equivalent. In another scenario, the supplier S2 308 has more of a supply (e.g., has a higher quantity) than the supplier S1 304, so the magnitude of the virtual force 170 is greater than the virtual force 168 over a distance. In this scenario, because the supplier S2 308 is closer to the deliverer D2 116 than the supplier S1 304 and the supplier S2 308 is in greater need of supplies, the deliverer D2 116 selects to travel along the AB link 136 towards the node A 120, which is towards the supplier S2 308. In another scenario, the supplier S1 304 has more of a supply (e.g., has a higher quantity) than the supplier S2 308, so the magnitude of the virtual force 168 is greater than the virtual force 170 over a distance. In this scenario, because the supplier S2 308 is closer to the deliverer D2 116 than the supplier S1 304, but the supplier S1 304 has a greater quantity of supplies, the deliverer D2 116 selects to travel along the AB link 136 in a direction based on the relationship of decay over distance and the difference in quantity. In other words there is a point where even though the supplier S1 304 has a greater quantity, because the supplier S1 304 is farther away than the supplier S2 308, the force from the supplier S1 304 will be greater due to the distance.

In another scenario, the supplier S2 308 has one particular supply of a low priority (e.g., low value for weight parameter), for example clothing and gear. The supplier S1 304, has one particular supply of a higher priority (e.g., higher value for weight parameter than S2 308), for example fuel. In this scenario, the virtual force 169 has a greater attraction than the virtual force 170 over a distance. In this scenario, if the deliverer D2 116 needs each of the supplies, the deliverer D2 116 selects to travel along the AB link 136 towards the node B 124, which is towards the supplier S1 304, because the supplier S1 304 has a higher priority supply (e.g., higher attractive force due to the weighting), than the supplier S2 308. Again, this selection will be influenced by the decay over distance and might change depending on whether the priority or decay is more influential.

Another type of virtual force is an auxiliary virtual force. Table 3 illustrates three exemplary auxiliary type virtual forces aimed at desired meta-properties. One is an oscillation avoidance auxiliary virtual force, another is a random perturbation auxiliary virtual force, and another is a inertia auxiliary virtual force.

TABLE 3

| Force name | Property | Magnitude | Direction | Parameters |
|---|---|---|---|---|
| Oscillation | Stability: | K/(distance * time) | Away from | WEIGHT, |
| Avoidance | Achieve stable | | recently visited | MAX_DIST, |
| | equilibrium | | positions | MAX_TIME |
| Random | Liveness: | Random | Random | MAX_WEIGHT |
| Perturbation | Avoid unstable | | | |
| | equilibrium | | | |
| Inertia | Efficiency: | Constant | Away from | WEIGHT |
| | Avoid | | motion in any | |
| | unnecessary | | direction | |
| | movement | | | |

The exemplary oscillation avoidance auxiliary virtual force is generated based on the past locations of the receiver and, in general, has a repulsive characteristic when received by the receiver. The oscillation avoidance auxiliary force has a weight parameter, a maximum distance parameter, and a maximum time parameter. The weight parameter allows the receiver (e.g., the deliverer) to determine the strength of this force as compared to other virtual forces also received by that same receiver. The weighting can vary between the same type forces. For example, if simulations find that the oscillation avoidance auxiliary force is more important for stability that the random perturbation auxiliary force, the oscillation avoidance auxiliary force can have a higher weight than the random perturbation auxiliary force. The weighting can also vary as compared between different types of forces. For example, reactive forces can have higher weights than auxiliary forces, since reactive forces involve actual diminished supplies, whereas auxiliary forces involve attempting to avoid instability of the system.

The max distance parameter sets a limit as to how far away a receiver is able to receive the virtual force. In some examples, the maximum distance is measured along an available path (e.g., one or more road links) and is not a straight line (e.g., line-of-sight) measurement. The max time parameter sets a limit as to how long the force remains (e.g., is received and/or should be used by the receiver), since this force is based on a history of prior movements. The magnitude of this force does vary with both distance and time. Referring to the direction column of Table 3, the reaction of the receiver is to move towards a path away from recently visited positions. In general, the purpose of this auxiliary force is to prevent a receiver from being trapped in a perpetual oscillation based on multiple other forces.

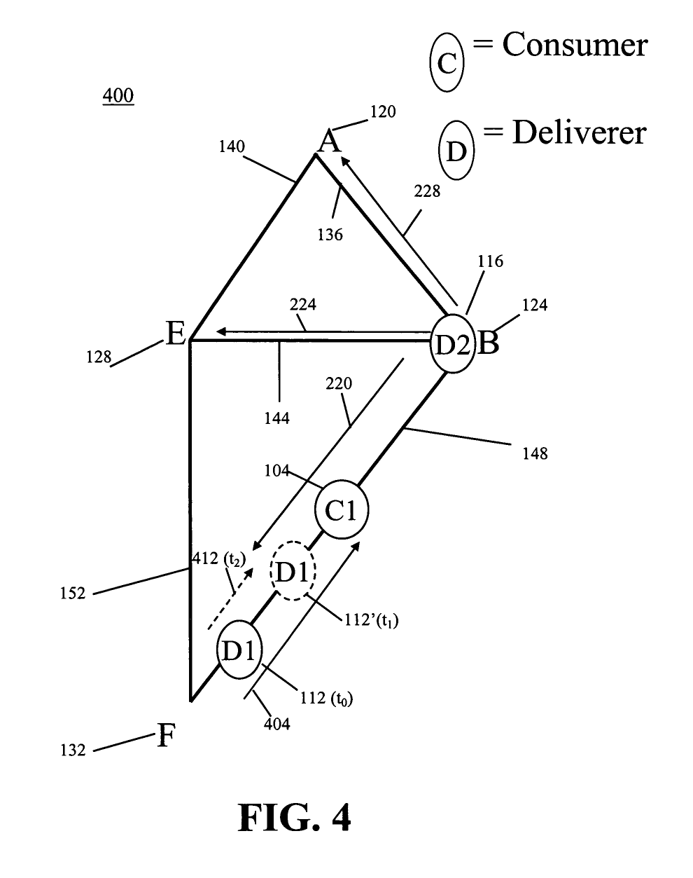

FIG. 4 illustrates an exemplary system 400, that includes an identical road network (i.e., the nodes 120, 124, 128, and 132, and the links 136, 140, 144, 148 and 152) and vehicles (i.e., the consumer C1 104 and the deliverers D1 112 and D2 116) as the system 100. The system 400 includes virtual forces 220, 224, and 228, which represent, in this example, deliverer repel anticipatory virtual forces of Table 1, and is generated based on the location of the deliverer D2 116. The system 400 also includes a virtual force 404, which represents a consumer parts refill attract reactive virtual force that is generated based on the supply needs of the consumer C1 104.

In an illustrative example, at time to, the deliverer D1 112 receives only the force 404 (force 412 is not existent at this time) and, determining that the deliverer D1 112 has the needed supply, the deliverer D1 112 selects to travel along the path link BF 148 towards the consumer C1 104. At some later time t₁, the deliverer D1 is located at a different position 112′ (indicated by the dashed circle), at which the deliverer D 112′ also receives the deliverer repel force 220. For this example, at location 112′, the repel anticipatory virtual force 220 is stronger (e.g., higher in magnitude and/or weight) than the attract reactive virtual force 404, so the deliverer D1 112′ selects to move away from the deliverer D2 116 towards node F 132. If only forces 404 and 220 exist and the environment local to D1 does not change (e.g., neither C1 nor D2 move, the quantity of supply of C1 remains constant no other vehicles move within a maximum distance value of the deliverer D1, etc.), then once the deliver D1 has moved past the maximum distance of force 220, so that force 220 is no longer received and/or a consideration in the selection process (e.g., back at the solid circle 112), the only force received by the deliverer 112 becomes the force 404. Once again, the deliverer D1 112 is then attracted towards the consumer C1 104 and this oscillation continues to repeat itself.

At some time t₂, the system 400 includes an oscillation avoidance auxiliary force 412 (indicated by the dashed arrow). The force 412 is generated after the deliverer D1 moves from its position indicated at 112 to its position indicated at 112′. Now with the force 412, there is an extra force pushing the deliverer D1 towards the consumer C1 104, and the oscillation is avoided. As described above, the force 412 does have an associated time parameter, so after some predefined time, the force 412 ceases to be an influence on the path selection process by the deliverer D1.

Referring to Table 3, another exemplary auxiliary force is the random perturbation auxiliary virtual force. The random perturbation force has a maximum weight parameter which limits the amount of influence that this auxiliary force can have. There is no distance parameter because this force is directly applied at and/or received by the receiver. The magnitude and the direction are random. In general, the purpose of this force is to prevent a vehicle from being stuck in position where the selection indicates that the vehicle should not move.

Referring to FIG. 3 as an illustrative example, the deliverer D2 116 receives the force 168, attracting the deliverer D2 116 towards the node B 124 and the deliverer D2 116 receives the force 170, attracting the deliverer D2 116 towards the node A 120. For this example, the forces 168 and 170, at the location of the deliverer D2 116, are equal, and thus the deliverer D2 116 is in equilibrium exactly where it is and therefore selects not to move. If, for example, these forces are reactive forces, indicating supplies are needed, the deliverer D2 116 should move to fulfill the supply need. The random auxiliary force gives a “nudge” to the deliverer D2 116, causing the deliverer D2 116 to move from its equilibrium position, in a random direction, at which later time the deliverer D2 116 will then be drawn to a direction based on one force now being stronger than the other.

Referring to Table 3, another exemplary auxiliary force is the inertia auxiliary virtual force. The inertia force has a weight parameter. The weight parameter allows the receiver (e.g., the deliverer) to determine the strength of this force as compared to other virtual forces also received by that same receiver. The weighting can vary between the same type forces. For example, if simulations find that the inertia auxiliary force is more important for stability that the random perturbation auxiliary force, the inertia auxiliary force can have a higher weight than the random perturbation auxiliary force. The weighting can also vary as compared between different types of forces. For example, reactive forces can have higher weights than auxiliary forces, since reactive forces involve actual diminished supplies, whereas auxiliary forces involve attempting to avoid instability of the system. There is no distance parameter because this force is directly applied at and/or received by the receiver. In general, the purpose of this force is to prevent a vehicle from starting to move to a position where the strength of the received force is small. Referring to the direction column of Table 3, this inertia force is in a direction away from motion is any direction. In other words, the inertia auxiliary force is applied opposite another received force to counteract that received force and allow that received force to influence the receiver as long as the received force is above some threshold strength set by the inertia force.

Referring to FIG. 3 as an illustrative example, the deliverer D 112 receives the force 160, attracting the deliverer D1 112 towards the node B 124. For this example, the force 160 is very small, but if the force is the only force received by the deliverer 112, then the deliverer reacts by moving towards the node B 124. The inertia auxiliary force acts as an efficiency factor, so that the deliverer D1 112 does not move unnecessarily towards the node B 124, simply because the force 160 is the only force being received by the deliverer D1 112.

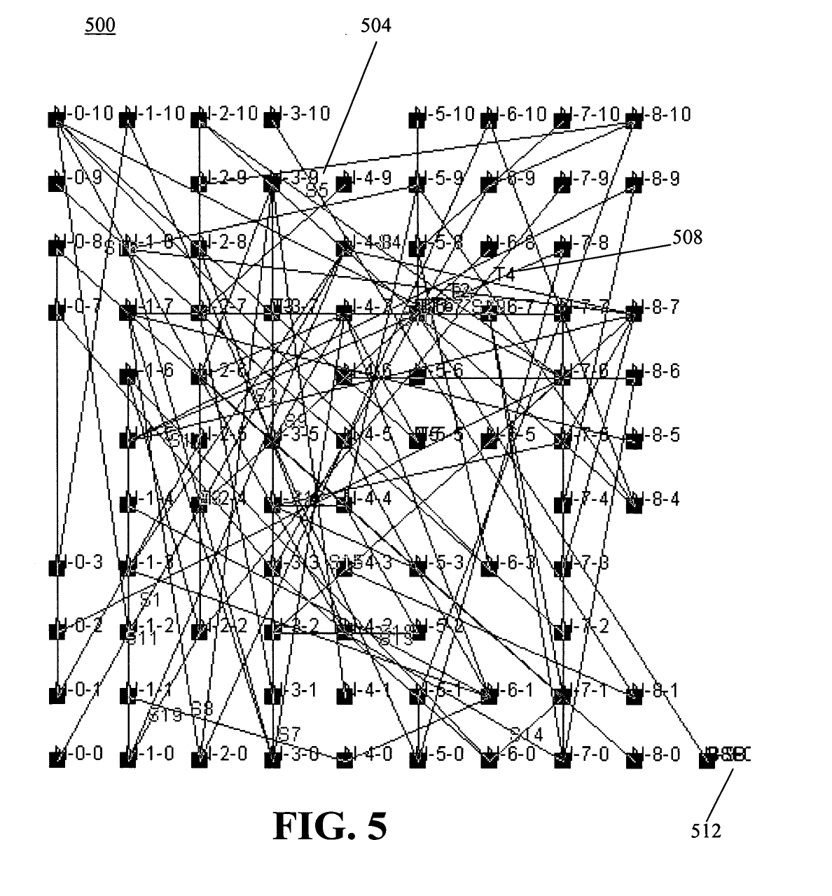

All of the above-described virtual forces can be used in combination in various implementations to dynamically generate a solution to logistics planning (which includes execution) involving a large transportation network involving multiple deliverers, consumers, and suppliers. One such implementation is in a computer simulation. FIG. 5 illustrates a screen shot 500 an exemplary computer simulation. The screen shot 500 of the computer simulation shows a transportation network that includes nodes and links between certain nodes. The transportation network is simulated as a grid. The nodes are numbered according to their position in the grid, using the format N-column#-row#, where the numbering starts from the bottom left-hand side, at node N-0-0. The lines between the nodes represent links (e.g., roads) between the nodes on which the vehicles can travel. The vehicles are represented using a combination of letters and numbers. For example, the screen shot 500 includes a consumer S5 504 (stryker 5), a deliverer T4 508 (truck 4), and a supplier BSB1 512 (brigade support battalion 1). Other vehicles are also depicted in screen shot 500. The consumer S5 504 is traveling along a path between nodes N-3-10 and N-8-1. The deliverer T4 508 is traveling along a path between nodes N-7-8 and N-5-7. The supplier BSB1 512 is located at a path at node N-9-0.

In an exemplary computer simulation, each vehicle is represented by a software agent that performs the functions associated with the corresponding vehicle. For example, a software agent corresponding to a consumer vehicle (e.g., S5 504) executes a specified mission (e.g., causes the consumer vehicle to travel along the transportation network in some specified manner). As the consumer vehicle moves along, the software agent causes anticipatory type virtual forces (e.g., Table 1 forces) to be generated. As the consumer vehicle moves along, the software agent also simulates the use of supplies and, with this use of its supplies, causes reactive type virtual forces (e.g., Table 2 forces) to be generated. Similarly, a software agent corresponding to a supplier vehicle (e.g., BSB1 512) executes a specified mission (e.g., causes the supplier vehicle to travel along the transportation network in some specified manner and/or to remain stationary at some point). The software agent simulates the availability of supplies and causes reactive type virtual forces (e.g., Table 2 forces) to be generated based on its quantity of supplies, that change as deliverers (e.g., T4 508) visit the supplier and take some of its supplies as needed. A software agent corresponding to a deliverer vehicle (e.g., T4 508) receives applicable virtual forces and reacts to those forces (e.g., selects a path on which to travel). The software agent corresponding to a deliverer also tracks the supplies on hand and the quantity changes, both decreases in supplies, as the deliverer gives supplies to consumers (e.g., S5 504), and increases in supplies, as the deliverer obtains supplies from suppliers (e.g., BSB1 512).

In this example, the computer simulation determines which deliverer receives which virtual forces and transmits those forces (e.g., passes information, messages, parameters, location information, etc.) to the corresponding software agent of the applicable deliverer(s). For example, the software agents of the consumer vehicles generate anticipatory type virtual forces based on the location of the consumers (e.g., a consumer attract anticipatory force of Table 1) as they move around the transportation network to execute their assigned missions. Based on their location, the computer simulation transmits these anticipatory type virtual forces to any deliverers within the maximum distance, along links, of those consumers. The information transmitted to the software agents of the applicable deliverers includes the magnitude and weight of the virtual force, along with the location of the consumer on which that particular virtual force is based. Similarly, the software agents of the deliverer vehicles generate anticipatory type virtual forces based on their location (e.g., a deliverer repel anticipatory force of Table 1) and the computer simulation transmits these forces to any deliverers within the maximum distance, along links, of those other deliverers. The information transmitted to the software agents of the applicable deliverers includes the magnitude and weight of the virtual force, along with the location of the deliverer on which that particular virtual force is based.

As a consumer uses its supplies, its software agent transmits this information, via a reactive type virtual force (e.g., a consumer parts refill attract reactive force of Table 2), to the deliverers within the maximum distance of that consumer. Similarly, as a supplier has a quantity of suppliers that the supplier can provide to a deliverer, its software agent transmits this information, via a reactive type virtual force (e.g., a supplier parts refill attract reactive force of Table 2), to the deliverers within the maximum distance of that supplier. The corresponding software agent of a deliverer can generate any combination of auxiliary type forces (e.g., one or more of the auxiliary forces of Table 3) and use those in its selection process.

During the selection process, the software agent corresponding to a deliverer determines which direction to travel along a path (e.g., a portion of a link). For example, if a deliverer is located on a link, whether stationary or in motion, the available paths for that deliverer include going in a forward direction along that link (e.g., the direction that deliverer is currently facing), or turning around and going in the opposite direction (e.g., the reverse direction that deliverer is currently facing) along that link. If a deliverer is located at a node, then the available paths are any of the links that are connected to that node. Available paths can change dynamically as the environment changes. For example, if a link is destroyed and becomes unnavigable (i.e., the vehicle can not drive over that damaged area), then that link is no longer an available path for the selection process. For the selection process, the software agent sums all of the received forces, which include those generated at the deliverer itself (e.g., auxiliary forces), and the net result determines which available path the deliverer selects. As described above, the use of an inertia auxiliary force can counteract some minimum net force, in which case the selected available path would be to remain stationary at the deliverer's present location.

In another implementation, real vehicles are used on a real transportation network. Each vehicle has computing devices in communication with transmitters and receivers, if applicable. The computing devices can include software agents similar to the computer simulation that perform the functions described. Then information regarding virtual forces and other information (such as location information) can be transmitted and received among the vehicles. The information can be encrypted to prevent any hostile eavesdroppers from using the transmitted information. Some examples can include a central coordinator that can act as a medium for collecting the information and retransmitting that information to the applicable vehicles, similar to the computer simulation. In some examples, location information can be based on a GPS signal. With or without a centralized coordinator, the selection process is performed locally at the deliverer.

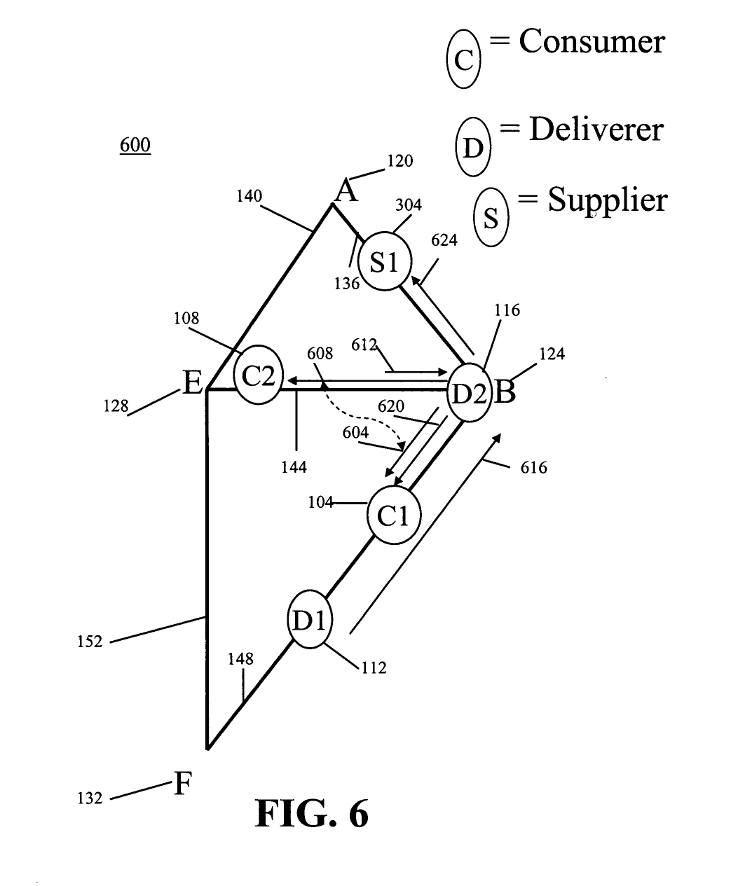

For an illustrative example, a system 600 shown in FIG. 6 is used to describe an exemplary selection process of a deliverer. The system 600 includes nodes A 120, B 124, E 128, and F 132 and links AB 136, AE 140, BE 144, BF 148, and EF 152. The system 600 also includes the consumers C1 104 and C2 108, the deliverers D1 112 and D2 116, and the supplier S1 304. The system 600 also includes virtual forces 604, 608, 616, 620, and 640. As described in Table 4, these virtual forces are of different types and represent the virtual forces that the deliverer D2 116 receives at a particular time for this example.

TABLE 4

| Force | Force | | | | |
|---|---|---|---|---|---|
| ref. # | name | Type | Magnitude | Direction | Parameters |
| 604 | Consumer | Anticipatory | 5 | Towards node E | WEIGHT = 3, |
| | Attract | | (Constant) | 128 (works in | MAX_DIST = 15 |
| | | | | conjunction | miles |
| | | | | with force 608) | |
| 608 | Consumer | Anticipatory | 5 | Towards node E | WEIGHT = 3, |
| | Attract | | (Constant) | 128 (works in | MAX_DIST = 15 |
| | | | | conjunction | miles |
| | | | | with force 604) | |
| 612 | Oscillation | Auxiliary | 5 at the location of | Away from | WEIGHT = 1, |
| | Avoidance | | D2 at the time t | node E 120 | MAX_DIST = 5 |
| | | | (K/(distance * time)) | | miles, |
| | | | | | MAX_TIME = 45 |
| | | | | | minutes |
| 616 | Deliverer | Anticipatory | 5 | Away from | WEIGHT = 3, |
| | Repel | | (Constant) | node F 132 | MAX_DIST = 25 |
| | | | | | miles |
| 620 | Consumer | Reactive | 5 at the location of | Towards node F | WEIGHT = 6, |
| | Parts Refill | | D2 based on the | 132 | MAX_DIST = 35 |
| | Attract | | parts quantity of | | miles |
| | | | the consumer | | |
| | | | (#parts/distance) | | |
| 624 | Supplier | Reactive | 5 at the location of | Towards node A | WEIGHT = 4, |
| | Parts Refill | | D2 based on the | 120 | MAX_DIST = 35 |
| | Attract | | parts quantity of | | miles |
| | | | the supplier | | |
| | | | (#parts/distance) | | |

In this example, the deliverer D2 116 selects a path based on the net result of all of the virtual forces exerted on the deliverer D2 116, as indicated in Table 4. The strength of the force can use some function of magnitude and weight, for example a simple multiplication of weight multiplied by magnitude. The first forces analyzed are the virtual forces 604 and 608, which work in conjunction with each other. The strength of each force is 15 (3*5) and the direction is towards the node F 132 for the force 604 and towards the node E 128 for the force 608. As described above, the net result of these forces is in a direction of the farthest consumer, which in this case is the consumer C2 108. The magnitude of the net force in the direction of the node E 128 can also be some function of the combination of these consumer attract anticipatory forces. For example, the function can be the average of all of the forces divided by the number of consumers generating these forces. In this case, the net result is a force of strength 7.5 along the link BE 144 in the direction of the node E 128.

The other force received by the deliverer D2 116 along the link BE 144 is the force oscillation avoidance auxiliary 612. This is generated by the deliverer D2 116 because at some recent time prior to its current position (e.g., within the last 45 minutes according the value of the max time parameter), the deliverer D2 116 traveled along the link BE 144 towards the node B 124. The strength of the force 612 at this time in the example is 5 (1*5) along the link BE 144 in the direction of the node B 124. This counteracts some of the force along link BE 144 that resulted from the forces 604, and 608, specifically, the force of strength 7.5 along the link BE 144 in the direction of the node E 128. The net result is a force of strength 2.5 along the link BE 144 in the direction of the node E 128.

Along the link BF 148, the deliverer D2 116 combines the forces 616 and 620 to determine the resulting force (the force 604 was already accounted for as described above). The strength of the force 616 is 15 (3*5) along the link BF 148 in the direction of the node B 124. The strength of the force 620 is 30 (6*5) along the link BF 148 in the direction of the node B 124. The net result is a force of strength 15 along the link BF 148 in the direction of the node F 132.

Along the link AB 136, the deliverer D2 116 receives only the force 624 and the strength is 20 (4*5) in the direction of the node A120. The deliverer D2 116 determines the net of all the forces is a strength of 2.5 along the link AB towards the node A 120. This determination is made by the sum of the forces in the forces which is 20 along the link AB 136 minus a net force of strength 2.5 along the link BE 144 towards the node E 128 minus a net force of strength 15 along the link BF 148 towards the node F 132. As a result of these forces, the deliverer D2 116 selects a path to travel along the link AB 136 towards the node A 120. This example is meant to be illustrative and more complex force functions can be used. For example, the force function can be computed from the gradient of local pressures imposed by the vehicles. Also, other parameters can be added into the selecting process. For example, how fast a vehicle can travel over a road can be factored into the force fiction.

In addition, if an inertia auxiliary force was also present, the net force of strength 2.5 would have to be greater than the strength of that inertia force for the deliverer D2 116 to move along the link AB 136. If the net force of strength 2.5 was not greater than the inertia auxiliary force, then the deliverer D2 116 would select a path which was to remain stationary at the node B 124. The deliverer D2 116 would remain stationary until the net strength of the combined forces changed (e.g., due to time and/or change of location of other vehicles) to overcome (e.g., be greater than) the inertia auxiliary force.

As described above, the values for the parameters of the virtual forces influence how the deliverer will react and can change the outcome. For example, if the weighting has a higher influence than the decay over distance for a reactive type force. To optimize the local decision making process, the set of parameters is tuned to optimize overall performance. For example, parameter tuning is performed for different weights allowing combination of different types of forces, exponents on different force decays, etc. There are different optimal parameter sets for different environments. For example, different uncertain environments can be characterized, at least, by noise in current visibility, time delays in visibility, predictive accuracy of OPLAN in terms of position, OPTEMPO, predictive accuracy of demand projections, adversary surprise, different weights rewarding best vs. penalizing worst cases. To that end, simulations can be run across many examples of this space to find optimal sets of weights for different postures. Although establishing these parameters by hand is possible, it is not an ideal situation. A genetic algorithm (GA) can be used to optimize parameter settings for different stress environments. A GA is able to easily search over the space of parameters evaluated over 100000's of runs on randomly generated scenarios consistent with a given stress level.

The above-described processes can be implemented in digital electronic circuitry, in computer hardware, firmware, software, or in any combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules and software agents can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described processes can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described processes can be implemented in a distributed computing the system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing the system can include clients and servers. A client and server are generally remote from each other and typically interact through a communication network. The relationship of client and server arises by virtue of computer programs running on the respective computers and having a client-server relationship to each other.

Unless explicitly stated otherwise, the term “or” as used anywhere herein does not represent mutually exclusive items, but instead represents an inclusive “and/or” representation. For example, any phrase that discusses A, B, or C can include A, B, C, AB, AC, BC, and ABC. In many cases, the phrase A, B, C, or any combination thereof is used to represent such inclusiveness. However, when such phrasing “or any combination thereof” is not used, this should not be interpreted as representing a case where “or” is not the “and/or” inclusive case, but instead should be interpreted as a case where the author is just trying to keep the language simplified for ease of understanding.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. An optimization method using virtual forces, the method comprising:
receiving a detected virtual force comprising a first virtual force, a second virtual force, or a combination thereof, the first virtual force being associated with an attractive characteristic and a first weighting parameter, the second virtual force being associated with a repulsive characteristic and a second weighting parameter; and
selecting, at an element associated with receiving the detected virtual force, a path from a plurality of available paths based on the detected virtual force.

2. The method of claim 1, wherein selecting comprises determining a direction in which to travel.

3. The method of claim 1, wherein selecting is associated with logistics planning.

4. The method of claim 4, wherein receiving further comprises receiving the detected virtual force by a deliverer of an item, the method further comprising:
associating a supplier of the item, a consumer of the item, or any combination thereof with the first virtual force; and
associating another deliverer of the item with the second virtual force.

5. The method of claim 1, wherein the first virtual force, the second virtual force, or any combination thereof represent a reactive characteristic.

6. The method of claim 1, wherein the first virtual force is based on a state associated with an element generating the first virtual force, the second virtual force is based on a state associated with an element generating the second virtual force, or any combination thereof.

7. The method of claim 6, wherein the state is associated with a quantity of an item.

8. The method of claim 1, wherein the first virtual force, the second virtual force, or any combination thereof represent an anticipatory characteristic.

9. The method of claim 1, further comprising generating the second virtual force based on a location of an element generating the second virtual force.

10. The method of claim 1, further comprising generating the second virtual force based on a first element associated with supplying an item such that other similar elements capable of also being associated with supplying the item are repulsed from a location of the first element.

11. The method of claim 1, wherein the first virtual force, the second virtual force, or any combination thereof represent an auxiliary characteristic.

12. The method of claim 11, wherein the auxiliary characteristic comprises an oscillation avoidance force, a random perturbation force, an inertia force, or any combination thereof.

13. The method of claim 1, wherein the path is associated with a transportation network.

14. The method of claim 13, further comprising representing the transportation network employing nodes and links.

15. The method of claim 14, wherein selecting further comprises selecting the path based on distances along the links, redundancy through the network, speeds on which links can be traveled, or any combination thereof.

16. The method of claim 14, wherein the links comprise roads, waterways, air routes, or any combination thereof.

17. The method of claim 1, wherein receiving further comprises receiving a signal representing the detected virtual force.

18. The method of claim 17, further comprising determining a distance between the element associated with receiving the detected virtual force and an element transmitting the virtual force based on a strength of the signal.

19. The method of claim 17, wherein the signal comprises location information, the method further comprising determining a distance between the element associated with receiving the detected virtual force and an element transmitting the virtual force based on the location information.

20. The method of claim 19, wherein the location information is based on a GPS signal.

21. The method of claim 1, wherein the first virtual force, the second virtual force, or any combination thereof is based on a force function.

22. The method of claim 21, wherein the force function comprises a maximum distance parameter.

23. The method of claim 21, wherein the force function comprises a traversability parameter.

24. The method of claim 21, wherein the force function comprises a gradient of local pressures.

25. The method of claim 21, further comprising determining a value associated with the force function employing a genetic algorithm.

26. The method of claim 1, further comprising determining the first weighting parameter, the second weighting parameter, or any combination thereof employing a genetic algorithm.

27. The method of claim 26 wherein determining further comprises employing, by the genetic algorithm, an environment in which the plurality of available paths is based.

28. The method of claim 1, wherein receiving further comprises receiving the detected virtual force based on a distance from a source of the detected virtual force.

29. The method of claim 28, wherein the distance is based on one or more of the available paths.

30. A system for optimizing solutions using local virtual forces, the system comprising:
a means for receiving a detected virtual force comprising a first virtual force, a second virtual force, or a combination thereof, the first virtual force being associated with an attractive characteristic and a first weighting parameter, the second virtual force being associated with a repulsive characteristic and a second weighting parameter; and
a means for selecting, at an element associated with receiving the detected virtual force, a path from a plurality of available paths based on the detected virtual force.

31. A computer program product, tangibly embodied in an information carrier, for optimizing solutions using local virtual forces, the computer program product including instructions being operable to cause data processing apparatus to:
receive a detected virtual force comprising a first virtual force, a second virtual force, or a combination thereof, the first virtual force being associated with an attractive characteristic and a first weighting parameter, the second virtual force being associated with a repulsive characteristic and a second weighting parameter; and
select, at an element associated with receiving the detected virtual force, a path from a plurality of available paths based on the detected virtual force.
